(19) United States
(12) Patent Application Publication
(10) Pub. No.: US 2006/0126254 A1
(43) Pub. Date: Jun. 15, 2006

(54) Protection of an integrated capacitor

(75) Inventors: Gerard Auriel, Gramat (FR); Philippe Merceron, Vernou Sur Brenne (FR)

Correspondence Address: Bryan A. Santarelli;GRAYBEAL JACKSON HALEY LLP, Suite 350, 155 - 108th Avenue NE, Bellevue, WA, 98004-5973, US

(73) Assignee: STMicroelectronics SA

(21) Appl. No.: 11/304,336

(22) Filed: Dec. 14, 2005

(30) Foreign Application Priority Data
Dec. 14, 2004 (FR) 04/52963

(51) Int. Cl. H02H 9/06

(52) U.S. Cl. 361/118

(57) ABSTRACT

A device for protecting at least one integrated capacitor against possible electrostatic discharges, comprising two conductive electrodes respectively connected to the capacitor electrodes and separated from each other by an air gap.

### PRIORITY CLAIM

This application claims priority from French patent application No. 04/52963, filed Dec. 14, 2004, which is incorporated herein by reference.

### BACKGROUND

1. Technical Field

The present invention generally relates to microelectronics and, more specifically, to integrated circuits comprising at least one capacitor, be it circuit-integrating passive components only (generally designated with trade name “IPD”) or circuit-integrating active and passive components (“IPAD”).

2. Discussion of the Related Art

Most capacitors made in integrated form are sensitive to electrostatic discharges (ESD). Such discharges are likely to damage the capacitor dielectric, even for relatively low electrostatic voltages (a few hundreds of volts, or even less than 100 volts).

To protect integrated capacitors and more generally electronic components, devices formed from protection diodes connected in parallel to the capacitors to shunt a possible electrostatic discharge to ground are known.

However, the arrangement of these components on substrates supporting one or several capacitors is generally performed after the capacitors have been manufactured. But prior to placing protection components, the risk of electrostatic discharge is present as soon as the two electrodes of a capacitor having one of them connected to ground (more generally to a contact likely to carry off a discharge) are formed.

A problem is that capacitors are not protected during manufacturing and especially during the successive handlings of the wafers, for as long as an integrated protection component has not been arranged on each substrate.

This problem is particularly critical for glass substrates used to form monolithic components with passive elements, where the diode-type protection component cannot be integrated on a glass substrate other than by the arranging of a silicon chip or another semiconductor substrate.

Further, diode-type integrated protection components have the disadvantage of having a leakage current that can cause an unwanted permanent power consumption in certain applications.

### SUMMARY

According to embodiments of the present invention, a device is provided for protecting integrated circuits which overcomes all or some of the disadvantages of known devices.

Embodiments according to the present invention are more specifically aimed at providing a protection device integrable with the capacitor to be protected.

Embodiments according to the present invention also provide a solution enabling protection of the capacitor without it being necessary to wait for the placing of a protection component on silicon, and preferentially as soon as the capacitor manufacturing is complete.

Embodiments according to the present invention also provide a solution compatible with current methods for manufacturing integrated circuits with passive elements and which requires no additional manufacturing step.

A first embodiment according to the present invention is an integrated protection device which protects the capacitor during the circuit lifetime.

A second embodiment according to the present invention provides a device for protecting the capacitor during its manufacturing and which generates no additional bulk with respect to the capacitor bulk.

An embodiment according to the present invention provide a device for protecting at least one integrated capacitor against possible electrostatic discharges, the device comprising two conductive electrodes respectively connected to the capacitor electrodes and separated from each other by an air gap.

According to an embodiment of the present invention, the conductive electrodes are formed in a same conductive level as one of the electrodes of the capacitor to be protected.

According to an embodiment of the present invention, the protection device is formed in the integrated circuit scribe lines.

According to an embodiment of the present invention, the protection device is formed in the surface of the integrated circuit containing the capacitor to be protected.

According to an embodiment of the present invention, the protection device is formed in a metallization level for receiving connection conductors of the integrated circuit.

Embodiments according to the present invention also provide a method for protecting at least one integrated circuit capacitor, including connecting the capacitor electrodes to two electrodes of a spark gap comprising an air gap.

According to an embodiment of the present invention, at the same time as a first electrode of the capacitor, two electrodes of an air spark gap are formed.

According to an embodiment of the present invention, one electrode of the air spark gap is connected, by a conductive track, i.e., traces, to a second electrode of the capacitor, said track being formed at the same time as this second electrode.

According to an embodiment of the present invention, one electrode of the air spark gap is electrically connected to a second electrode of the capacitor at the same time as a contact area of this second electrode to the outside of the circuit is being formed.

Features and advantages of the present invention will be discussed in detail in the following non-limiting description of specific embodiments in connection with the accompanying drawings.

### BRIEF DESCRIPTION OF THE DRAWINGS

FIG. 1 shows a schematic diagram of an assembly of a protection device according to an embodiment of the present invention;

FIGS. 2A, 2B, 2C, 2D, 2E, and 2F partially and schematically show cross-section views of an integrated circuit with passive components at different steps of a manufacturing process according to a first embodiment of the present invention;

FIGS. 3A, 3B, 3C, 3D, 3E, and 3F are partial top views at the respective steps illustrated by FIGS. 2A, 2B, 2C, 2D, 2E, and 2F according to an embodiment of the invention;

FIGS. 4A, 4B, and 4C illustrate, in top view and in cross-section view, alternative embodiments of the present invention;

FIG. 5 schematically shows in cross-section view a structure integrating passive elements, including a capacitor and its protection device according to a second embodiment of the present invention; and

FIGS. 6A and 6B show, respectively in cross-section view and in top view, a third embodiment of the present invention.

### DETAILED DESCRIPTION

For clarity, same elements have been designated with same reference numerals in the different drawings and, further, as usual in the representation of integrated circuits, the various drawings may not be to scale. Further, only those steps and elements which are useful to the understanding of embodiments of the present invention have been shown in the drawings and will be described hereafter. In particular, the different elements, especially active, likely to be integrated with one or several capacitors protected by a device according to an embodiment of the present invention have not been detailed, embodiments of the present invention being compatible with conventional forming of such active or passive elements. Further, the techniques for forming (deposition, etch, etc.) the different components have not been detailed, embodiments of the present invention being compatible with conventional techniques for forming capacitors and other passive elements on a substrate, be it made of glass or of a semiconductor material.

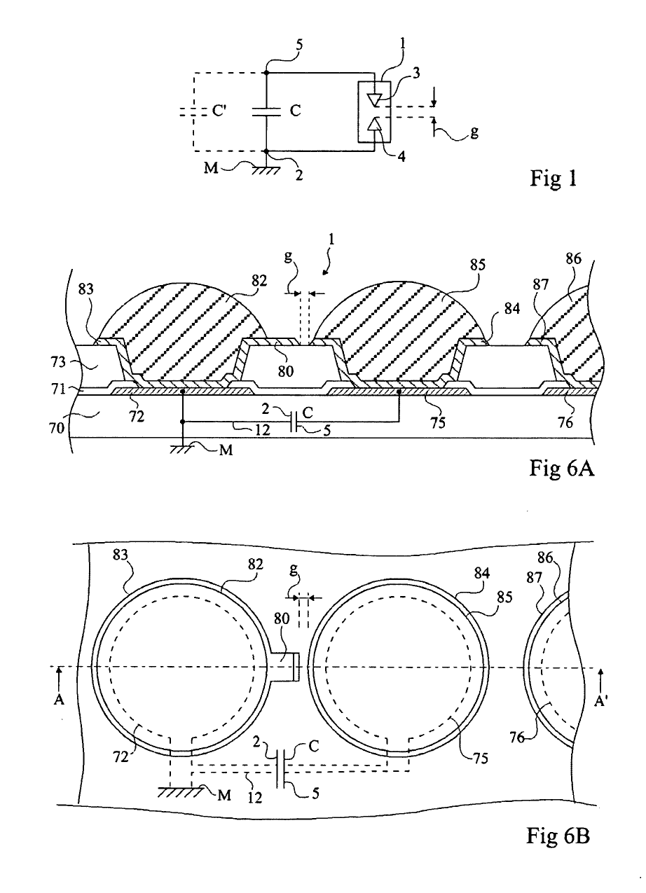

FIG. 1 shows the schematic diagram of an assembly associating a capacitor C with a protection device 1 according to an embodiment of the present invention. Device 1 is connected in parallel with capacitor C. In the shown example, a first electrode 2 of the capacitor is connected to ground M, its second electrode 5 being intended to be connected to an internal or external element (not shown).

Device 1 is an air spark gap having its two electrodes 3 and 4, in the example of FIG. 1, connected respectively to electrodes 5 and 2 of capacitor C. Electrode 5 of the capacitor is likely to receive an electrostatic discharge, possibly via a contact to which it is connected.

As an alternative, one of the capacitor electrodes is connected to a contact for carrying off an electrostatic discharge (for example, a contact accessible during the manufacturing or intended to be connected to a supply line) while the other may remain indirectly accessible.

According to another variation, no electrode of the capacitor is, at the end of the manufacturing, connected to a line likely to directly carry off charges. In this case, the capacitor does not risk, in principle, electrostatic damage during its operation. However, it may be equipped with a protection device for the case where, incidentally, one of its electrodes would be connected, even temporarily, to ground (for example, during manufacturing).

A same protection device 1 may protect several capacitors connected in parallel (in FIG. 1, capacitor C and a capacitor C′ shown in dotted lines) or in series.

The fact of forming an air spark gap has the advantage (especially, over the use of a solid dielectric spark gap) that it can be used several times.

The spark gap according to an embodiment of the present invention is sized, in particular regarding gap “g” between its electrodes 3 and 4, so that its puncture or breakdown voltage is smaller than the breakdown voltage of the dielectric of capacitor C to be protected.

The value of the breakdown voltage in air according to the inter-electrode distance of an air spark gap is on the order of 50 V/μm between 0 and approximately 6 μm. This breakdown voltage then varies with a slope on the order of 3 V/μm for gaps greater than approximately 6 μm. This property is described, for example, in articles “Field-induced breakdown ESD damage of magnetoresistive recording heads” by A. Wallash and M. Honda, ESD/EOS Symposium proceedings 1997, pp. 382-385 and “Electromagnetic interference damage to giant magnetoresistive recording heads” by A. Wallash and D. Smith, ESD/EOS Symposium proceedings 1998, pp. 368-374, both hereby incorporated by reference.

Thus, an air spark gap with a gap g smaller than approximately 6 μm will have a breakdown voltage ranging between 0 and approximately 300 volts (approximately 100 volts for a gap g of approximately 2 μm).

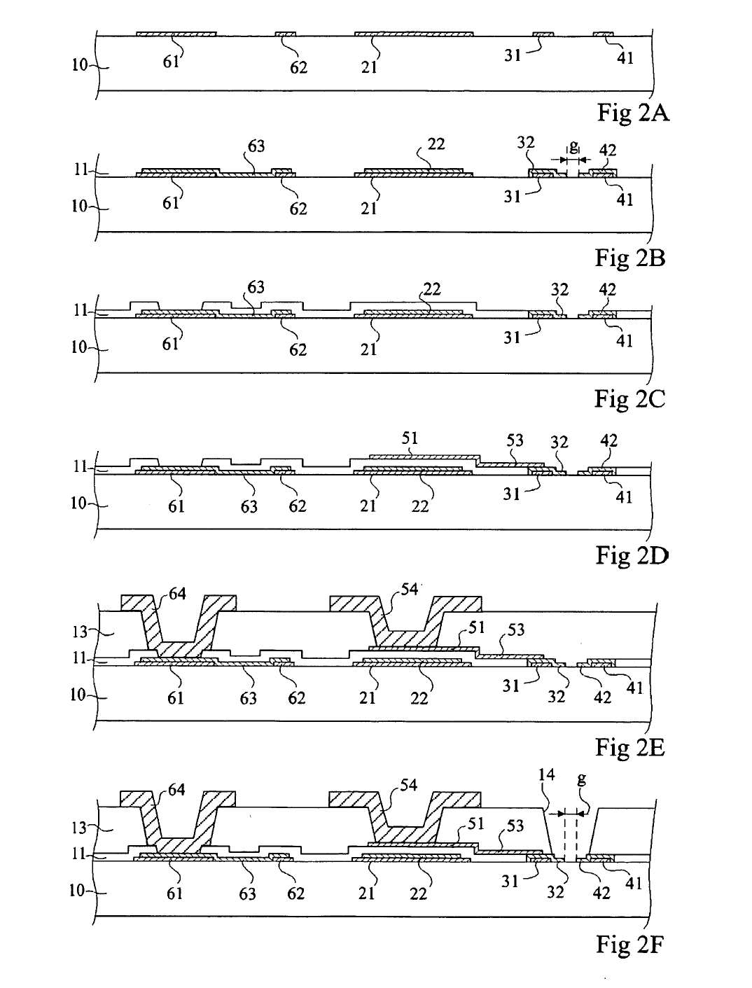

FIGS. 2A, 2B, 2C, 2D, 2E, and 2F are partial cross-section views of an integrated circuit with passive components, among which are a capacitor and its air spark gap at different steps of an embodiment of a manufacturing method according to the present invention.

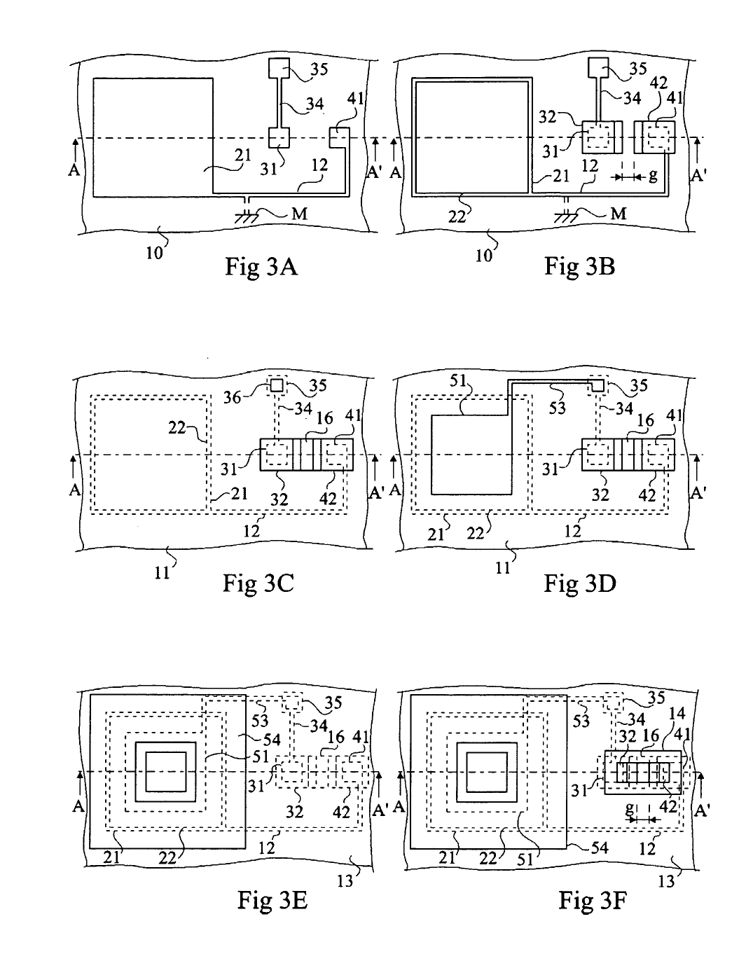

FIGS. 3A, 3B, 3C, 3D, 3E, and 3F are partial top views of the capacitor and of its air spark gap at the respective steps illustrated in FIGS. 2A to 2F, having their cross-sections performed along lines A-A′ of FIGS. 3A to 3F.

Embodiments according to the present invention will be described hereafter in relation with an example of the forming of an integrated circuit with passive components on a glass substrate. The embodiments however more generally apply to an integrated circuit with active and passive components and to substrates of various natures. In the case of a semiconductor substrate (for example, made of silicon) with active components, the active components may be formed before the steps which will be described hereafter.

As illustrated in FIGS. 2A and 3A, in a first step, a conductive layer is deposited on a substrate 10 and is etched to leave at least one pattern 21 corresponding to first electrode 2 of the capacitor.

Electrode 2 of the capacitor is intended to be connected (either directly, or by means of vias or the like) to a ground contact M (or to a supply contact) by means of a conductive trace 12 formed in the same conductive level as pattern 21. As an alternative (for example, for the case where the capacitor is intended to be afterwards at a floating potential), pattern 21 of electrode 2 of capacitor C is electrically connected to a conductive area likely to receive or to carry off (for example, by a contact with the outside), during or after manufacturing, an electrostatic discharge.

In the shown embodiment of the present invention, two conductive pads 31 and 41 may be formed at the same time as electrode 2. Pad 41 may be either directly connected to ground M or, as illustrated in FIG. 3A, connected to electrode 2 of the capacitor by trace 12 (itself connected or not to ground M). Pad 31 is connected, by a trace 34, to another pad 35 which will be used hereafter to contact second electrode 5 of the capacitor. As an alternative, pad 35 is an extension of pad 31.

In the left-hand portion of FIG. 2A, two pads 61 and 62 defining the terminals of an integrated resistive element (optional) have been shown.

The conductive layer forming areas 12, 21, 31, 34, 35, 41, 61, and 62 is, for example, aluminum.

As illustrated in FIGS. 2B and 3B, in a second step, a second conductive level is deposited on the structure and is etched to form at least one pattern 22 of electrode 2 of the capacitor and patterns 32 and 42 in respective contact with pads 31 and 41. Patterns 32 and 42 define gap g of the air spark gap. Further, the resistive element is formed in this conductive level by a track 63 connecting pads 61 and 62.

The layer forming areas 22, 32, 42, and 63 is, for example, tantalum nitride (TaN). A tantalum nitride area (not shown) may also be deposited on pad 35. On region 21 and on pads 31 and 41, this layer may be used to improve the surface evenness for the subsequent depositions. An advantage of forming the spark gap between TaN rather than aluminum tracks is that tantalum nitride can be deposited over a smaller thickness and can be etched with more accuracy. Further, tantalum nitride is less susceptible to corrosion than aluminum.

As illustrated in FIGS. 2C and 3C, in a third step, an insulating layer 11 is deposited at least over electrode 2 (21, 22) of the capacitor formed at the previous step to form its dielectric. Insulating layer 11 is, for example, deposited over the entire structure and etched above the spark gap area. A window 16 (FIG. 3C) is thus defined in layer 11 exposing the entire air spark gap (electrodes 3 and 4 and gap g). Preferably, layer 11 is also open (pattern 36) above pad 35 in preparation of a contact to electrode 5 of the capacitor which will be formed subsequently. The thickness of layer 11 depends on the dielectric thickness desired for capacitor C.

As illustrated in FIGS. 2D and 3D, in a fourth step, once the dielectric has been formed, a conductive layer, preferably metallic (for example, aluminum) is deposited and etched to leave at least pattern 51 of second electrode 5 of the capacitor.

According to an embodiment, electrode 5 of the capacitor is connected to electrode 3 of the spark gap by the conductive level where this electrode 5 is formed. For this purpose, a conductive trace 53 is formed in the same metal as pattern 51 to connect it to pad 35 (as an alternative, directly to pad 32).

An advantage is that the capacitor is then protected as soon as its second electrode 5 has been formed. Indeed, it may be enough for a ground contact to have been taken, which is generally the case on handling of the wafers under manufacturing, for the spark gap to have played its protection role.

As illustrated in FIGS. 2E and 3E, in a fifth step, an insulating layer 13 (generally thicker than layer 11) is deposited over the entire structure and is etched according to contact patterns of electrode 5 and of at least one first terminal (pad 61) of the resistive element. Then, a metallization is formed to form a contact area 54 of electrode 5 at the same time as a contact area 64 of the first terminal of the resistive element. In the shown example, it is assumed that the other end 62 of the resistor is connected by a conductive trace (not shown) to another contact area or to another circuit element.

As illustrated in FIGS. 2F and 3F, in a sixth step, insulating layer 13 is opened above the spark gap to create a well 14 for reestablishing the air gap g.

In the above-described embodiment, the only step during which the spark gap may be inoperable is the fifth step where it is filled with insulating layer 13. As an alternative, well 14 may be formed in the fifth step at the same time as the contact openings, a cap being then provided to cover the well and to trap a quantity of air before the metallization is deposited.

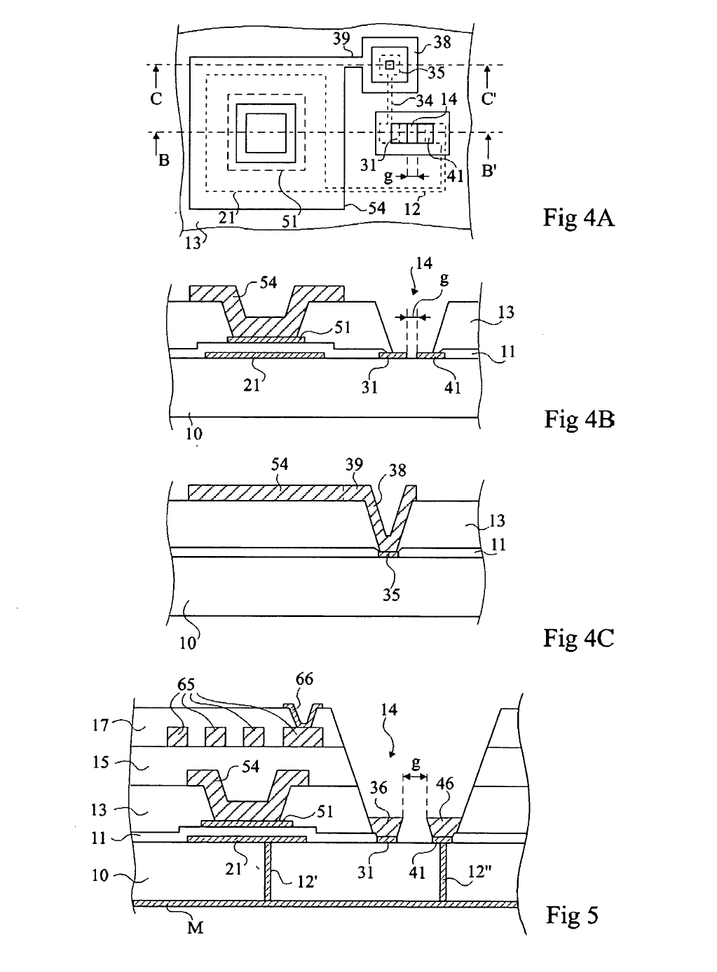

FIGS. 4A, 4B, and 4C illustrate, respectively in a top view and in cross-section views along lines B-B′ and C-C′ of FIG. 4A, alternative embodiments of a capacitor associated with an air spark gap. These drawings should be compared with FIGS. 2F and 3F and show the structure obtained after forming of contact area 54 of electrode 5 of the capacitor.

A first illustrated variation is the absence of the tantalum nitride layer. Electrodes 2, 3, and 4 are formed in a single conductive level (for example, aluminum), the interval between pads 31 and 41 defining gap g of the spark gap.

A second illustrated embodiment is the forming of the conductive path between second electrode 5 (pattern 51) of the capacitor and electrode 3 of the spark gap by contact metallization 54 (for example, copper) of electrode 5. Insulating layer 13 is then opened above pad 35 (FIG. 4C) and a contact area 38 is formed in the metallization. Contact areas 54 and 38 are connected by a trace 39 in the same level.

According to the second illustrated embodiment, as soon as the contact is established between electrode 5 and pad 35, the capacitor is protected against electrostatic discharges by means of spark gap 1.

FIG. 5 shows, in a simplified cross-section view, another embodiment of the present invention and also illustrates the integration of other passive components with capacitor C to be protected.

It is started from a substrate 10 (for example, glass) on which are formed first electrode 2 (pattern 21) of the capacitor as well as conductive pads 31 and 41 of spark gap 1. In the example of FIG. 5, the existence of a conductive ground plane M at the rear surface of substrate 10 to which are connected pattern 21 and pad 41 by vias 12′ and 12″ is assumed.

As previously described, a layer 11 forming the dielectric of capacitor 2 is deposited on the structure thus obtained and is opened at the level of spark gap 1. Then, contact area 54 of electrode 5 of the capacitor is formed after deposition of area 51 and after deposition and opening of an insulating layer 13.

In this embodiment, an inductive element (planar winding) 65 is formed in a conductive level (for example, copper) deposited on an insulating layer 15 covering the structure, to form an inductor 65. An end contact of the inductor is taken by means of a contact 66 formed after deposition of another insulating level 17, the other end of the inductor being connected to another contact or to another integrated element (not shown).

In this embodiment of the present invention, all insulating levels 13, 15, and 17 are opened (well 14) at the level of spark gap 1. Further, pads 36 and 46 are formed in the conductive level used to form inductance 65 to form, above pads 31 and 41, the two electrodes 3 and 4 of the spark gap.

As an alternative, the conductive level in which contact area 54 of electrode 5 of the capacitor has been formed will be used to form pads 36 and 46, to enable protection of the capacitor sooner in the manufacturing cycle.

The fact of forming the spark gap electrode in a relatively thick metal level (for example, the contact copper) as compared with the base level(s) (for example, the aluminum and/or tantalum nitride) enables providing, by etching, pads 36 and 46 with the shape of an inverted truncated pyramid. An advantage is that this moves the location of the electric arc away from substrate 10.

The air spark gap, be it formed according to the first, to the second, or to the other embodiment, can be placed in the scribe lines of the integrated circuit chips. An advantage is that the air spark gaps which are used to protect the capacitors during the handlings which follow their full-wafer manufacturing generate no additional bulk in the formed circuits. This embodiment is more specifically intended for the case where an active protection circuit is subsequently placed on the formed structure. Indeed, such an active circuit being generally arranged on the wafer before scribing, the capacitors are then protected by the active circuits.

The air spark gap may also be arranged within the circuit. An advantage then is that this spark gap can be used during the integrated circuit lifetime. For this purpose, a cap (not shown) may be placed on the window formed over the level of gap g of the spark gap to preserve an air volume.

FIGS. 6A and 6B illustrate, respectively in a cross-section and in a top view, a third embodiment of the present invention, the cross-section being performed along line A-A′ of FIG. 6B.

According to this embodiment, an air spark gap is formed by using conductive circuit connection bumps.

To simplify the representation of the drawings, the different components integrated in the circuit have not been shown. Only capacitor C to be protected has been schematically shown in substrate 70. It is assumed that contact areas 72 and 75 with ground M and electrodes 2 and 5 of the capacitor have been formed in a metal level. In the example of FIGS. 6A and 6B, a third area 76 illustrating another contact to be taken out of the circuit has been partially shown. After deposition of a first insulating layer 71 above open areas 72, 75, and 76, a second, thicker insulating layer 73 is deposited and opened at the level of contact areas 72, 75, and 76. A conductive layer is then deposited and is etched according to the pattern of areas 83, 84, and 87 for receiving conductive bumps 82, 85, and 86, for example, made of tin.

In this embodiment of the present invention, one and/or the other of areas 83 and 84 comprises an extension 80 towards the neighboring area. This results in a reduced air gap between conductive areas of bumps 82 and 85. This gap g forms an air spark gap for protecting capacitor C against electrostatic discharges.

The embodiment illustrated in FIGS. 6A and 6B may be combined with one of the previous embodiments to protect capacitor C on the one hand during its manufacturing, then permanently by means of an external air spark gap 1. For example, this embodiment may be combined with an air spark gap formed in the scribe lines, which then has the advantage of protecting the capacitor both during the manufacturing then during its operation, without increasing the integrated circuit bulk.

An advantage according to embodiments of the present invention is that the formed protection device is bidirectional.

Another advantage according to embodiments of the present invention is that the protection device generates little or no leakage current, conversely to a diode-type protection circuit.

Another advantage according to embodiments of the present invention is that it requires no additional manufacturing step with respect to the normal steps of manufacturing of an integrated circuit with passive and possibly active elements. Indeed, according to some embodiments it requires neither additional mask nor an additional deposition.

Of course, the present invention is likely to have various, alterations, improvements, and modifications which will readily occur to those skilled in the art.

In particular, the selection of the dimensions of the air spark gap is within the abilities of those skilled in the art based on the functional indications given hereabove.

Moreover, the implementation of embodiments according to the present invention, be it on an insulating or semiconductor substrate, with or without active component(s), is within the abilities of those skilled in the art based on manufacturing techniques current in microelectronics, especially to select the adapted methods of deposition, pattern definition, etch, etc. as well as possible intermediary steps (bonding layer, etch stop, step crossing, etc.).

Furthermore, a system such as a computer system may incorporate an integrated circuit having, or manufactured with, one or more of the above-described protective air gaps.

Such alterations, modifications, and improvements are intended to be part of this disclosure, and are intended to be within the spirit and the scope according to embodiments of the present invention. Accordingly, the foregoing description is by way of example only and is not intended to be limiting.

What is claimed is:

1. A device for protecting at least one integrated capacitor against possible electrostatic discharges, comprising two conductive electrodes respectively connected to the capacitor electrodes and separated by an air gap.

2. The device of claim 1, wherein said conductive electrodes are formed in a same conductive level as one of the electrodes of the capacitor to be protected.

3. The protection device of claim 1, formed in the integrated circuit scribe lines.

4. The protection device of claim 1, formed in the surface of the integrated circuit containing the capacitor to be protected.

5. The protection device of claim 1, formed in a metallization level for receiving conductive bumps for connection of the integrated circuit.

6. A method for protecting at least one integrated circuit capacitor, comprising connecting the capacitor electrodes to two electrodes of a spark gap comprising an air gap.

7. A method for forming an integrated device for protection of at least one capacitor, comprising forming, at the same time as a first electrode of the capacitor, two electrodes of an air spark gap.

8. The method of claim 7, wherein one electrode of the air spark gap is connected, by a conductive trace, to a second electrode of the capacitor, said trace being formed at the same time as the second electrode.

9. The method of claim 8, wherein one electrode of the air spark gap is electrically connected to a second electrode of the capacitor at the same time as a contact area of the second electrode to the outside of the circuit is formed.

10. A method, comprising:
accumulating an electrical charge at a first node low resistance first of an electrostatic-sensitive device; and
conducting the electrical charge across a gap to a second node of the low resielectrostatic-sensitive device, the gap being separate from the electrostatic-sensitive device.

11. The method of claim 10 wherein conducting the electrical charge comprises conducting the electrical charge across the gap when a potential across the gap is lower than a damage-threshold potential of the electrostatic-sensitive device and is higher than an operational potential of the electrostatic-sensitive device.

12. An integrated circuit, comprising:
an electrostatic-sensitive device having first and second nodes;
a first electrode coupled to the first node;
a second electrode coupled to the second node; and
a gap disposed between the first and second electrodes and operable to allow an electrostatic-discharge current to flow between the first and second electrodes.

13. The integrated circuit of claim 12, further comprising:
a conductive layer; and
wherein the first and second electrodes are disposed in the layer.

14. The integrated circuit of claim 12, further comprising:
a conductive layer; and
wherein one of the first and second nodes of the electrostatic-sensitive device and the first and second electrodes are disposed in the layer.

15. The integrated circuit of claim 12 wherein the electrostatic-sensitive device comprises a capacitor.

16. The integrated circuit of claim 12, further comprising a fluid disposed in the gap.

17. The integrated circuit of claim 12, further comprising a gas disposed the gap.

18. The integrated circuit of claim 12, further comprising air filling the gap.

19. The integrated circuit of claim 12 wherein the gap:
comprises a width; and
is operable to allow the electrostatic-discharge current to flow in response to a predetermined voltage being across the first and second nodes, the predetermined voltage being related to the width of the gap.

20. The integrated circuit of claim 12 wherein the first and second electrodes respectively comprise first and second conductive connection bumps.

21. The integrated circuit of claim 12, further comprising:
a substrate having an edge; and
wherein one of the first and second nodes of the electrostatic-sensitive extends to the edge of the substrate.

22. An electronic system, comprising:
an integrated circuit, including,
an electrostatic-sensitive device having first and second nodes,
a first electrode coupled to the first node,
a second electrode coupled to the second node, and
a gap disposed between the first and second electrodes and operable to allow an electrostatic-discharge current to flow between the first and second electrodes.

23. A method, comprising:
completing an integrated electrostatic-sensitive device at a first time; and
completing an integrated electrostatic-discharge device coupled across first and second nodes of the device at substantially the first time.

24. The method of claim 23 wherein completing the integrated electrostatic-discharge device comprises completing an electrostatic-discharge gap coupled across the first and second nodes of the device.

25. A wafer, comprising:
an electrostatic-sensitive device having first and second nodes;
a first electrode coupled to the first node;
a second electrode coupled to the second node; and
a gap disposed between the first and second electrodes and operable to allow an electrostatic-discharge current to flow between the first and second electrodes.

26. The wafer of claim 25, further comprising:
a scribe line; and
wherein the gap is disposed on the scribe line.

27. The wafer of claim 25, further comprising:
a scribe line; and
wherein one of the first and second electrodes is disposed on the scribe line.
